(19) United States
(12) Patent Application Publication
(10) Pub. No.: US 2019/0020089 A1
(43) Pub. Date: Jan. 17, 2019

(54) DIELECTRIC WAVEGUIDE INPUT/OUTPUT STRUCTURE AND DIELECTRIC WAVEGUIDE DUPLEXER INCLUDING THE SAME

(71) Applicant: Murata Manufacturing Co., Ltd., Kyoto-fu (JP)

(72) Inventor: Yukikazu YATABE, Nagaokakyo-shi (JP)

(73) Assignee: Murata Manufacturing Co., Ltd., Kyoto-fu (JP)

(21) Appl. No.: 16/135,946

(22) Filed: Sep. 19, 2018

Related U.S. Application Data
(63) Continuation of application No. PCT/JP2017/014169, filed on Apr. 5, 2017.

(30) Foreign Application Priority Data
Apr. 8, 2016 (JP) 2016-077884

(51) Int. Cl. H01P 1/208; H01P 1/213; H01P 5/107; H01P 7/10

(52) U.S. Cl. CPC H01P 1/2084; H01P 7/10; H01P 5/107; H01P 1/213

(57) ABSTRACT

A dielectric waveguide includes a first resonator and a second resonator. On a surface of a printed circuit board, a line, an impedance matching portion, gaps, a first conductor non-formation portion having a crank shape, a second conductor non-formation portion having a crank shape, and a surface ground are formed. A back surface ground is formed on a back surface of the printed circuit board. Furthermore, via holes connecting the surface ground and the back surface ground are formed in the printed circuit board. A first dielectric exposure portion and a second dielectric exposure portion are provided on bottom surfaces of the first resonator and the second resonator, respectively, and a third dielectric exposure portion is provided on a side surface of the dielectric waveguide and near the line. Such a dielectric waveguide is mounted on the printed circuit board.

### CROSS-REFERENCE TO RELATED APPLICATIONS

This application claims benefit of priority to International Patent Application No. PCT/JP2017/014169, filed Apr. 5, 2017, and to Japanese Patent Application No. 2016-077884, filed Apr. 8, 2016, the entire contents of each are incorporated herein by reference.

### BACKGROUND

### Technical Field

The present disclosure relates to a dielectric waveguide input/output structure in which a dielectric waveguide is directly mounted on a printed circuit board, and particularly relates to a dielectric waveguide input/output structure that allows input/output to be simultaneously performed to two dielectric waveguide resonators in a TE mode. In addition, the present disclosure relates to a dielectric waveguide duplexer including the dielectric waveguide input/output structure.

### Background Art

For a dielectric waveguide that is able to be directly mounted on a printed circuit board, an input/output structure for connecting the dielectric waveguide and a line such as a microstrip line or a coplanar line is needed. For a dielectric waveguide such as a dielectric waveguide duplexer, a branch structure for distributing one signal to two dielectric waveguides is needed.

For example, Japanese Unexamined Patent Application Publication No. 5-167315 describes a waveguide branch structure for distributing a signal in a waveguide to two waveguides. In addition, Japanese Unexamined Patent Application Publication No. 2004-312217 describes a dielectric waveguide filter having a waveguide branch structure for a signal in a line to two resonators.

### SUMMARY

However, the waveguide branch structure disclosed in Japanese Unexamined Patent Application Publication No. 5-167315 or Japanese Unexamined Patent Application Publication No. 2004-312217 needs a member other than the dielectric waveguide. Thus, there is a problem that the structure of the dielectric waveguide becomes complicated and the dimension thereof increases.

Accordingly, the present disclosure provides a dielectric waveguide input/output structure that solves the above problem, does not need a member other than a printed circuit board and a dielectric waveguide, and has a waveguide branch structure, and a dielectric waveguide duplexer including the dielectric waveguide input/output structure.

A dielectric waveguide input/output structure according to the present disclosure is a dielectric waveguide input/output structure comprising a printed circuit board on which a line is provided, and a dielectric waveguide, the dielectric waveguide and the line being connected to each other. The dielectric waveguide includes a first resonator and a second resonator disposed adjacent to each other, on a surface of the printed circuit board, an impedance matching portion connected to an end of the line and extending from an outer side portion to an inner side portion of a bottom surface of the dielectric waveguide, and a gap provided at each side of the line. The dielectric waveguide further includes a first conductor non-formation portion connected to the gap, disposed on a bottom surface of the dielectric waveguide and at the first resonator side, and having a crank shape, and a second conductor non-formation portion connected to the gap, disposed on the bottom surface of the dielectric waveguide and at the second resonator side, and having a crank shape. The dielectric waveguide also includes a surface ground provided on a remaining part other than the first conductor non-formation portion and the second conductor non-formation portion are provided, a back surface ground is provided on a back surface of the printed circuit board, and via holes connecting the surface ground and the back surface ground are provided so as to surround the first conductor non-formation portion and the second conductor non-formation portion. In addition, the dielectric waveguide includes a first dielectric exposure portion and a second dielectric exposure portion are provided on bottom surfaces of the first resonator and the second resonator so as to overlap the first conductor non-formation portion and the second conductor non-formation portion, respectively, and a third dielectric exposure portion is provided on a side surface of the dielectric waveguide and near the line. The dielectric waveguide is mounted on the printed circuit board such that the first conductor non-formation portion and the second conductor non-formation portion overlap the first dielectric exposure portion and the second dielectric exposure portion, respectively.

According to the present disclosure, an additional member is not needed, and thus a small-sized dielectric waveguide input/output structure having a waveguide branch structure and a dielectric waveguide duplexer including the dielectric waveguide input/output structure are obtained.

### BRIEF DESCRIPTION OF THE DRAWINGS

FIG. 1 is an exploded perspective view for explaining a dielectric waveguide input/output structure according to a first embodiment of the present disclosure;

FIG. 2 is a partially enlarged view of FIG. 1;

FIG. 3 is a plan view for explaining the dimensions of each portion of the dielectric waveguide input/output structure according to the first embodiment;

FIG. 4 is a diagram showing simulation results of bandpass characteristics (S21) of the dielectric waveguide input/output structure according to the first embodiment;

FIG. 5 is a diagram showing simulation results of a field strength distribution of the dielectric waveguide input/output structure according to the first embodiment;

FIG. 6 is a diagram showing simulation results of a field strength distribution of the dielectric waveguide input/output structure according to the first embodiment;

FIG. 7 is a diagram showing simulation results of an outer portion Q of the dielectric waveguide input/output structure according to the first embodiment;

FIG. 8 is a diagram showing simulation results of the outer portion Q of the dielectric waveguide input/output structure according to the first embodiment;

FIG. 9 is a diagram showing simulation results of the outer portion Q of the dielectric waveguide input/output structure according to the first embodiment;

FIG. 10 is an exploded perspective view for explaining a dielectric waveguide duplexer according to a second embodiment including the dielectric waveguide input/output structure;

FIG. 11 is a diagram showing simulation results of the dielectric waveguide duplexer according to the second embodiment including the dielectric waveguide input/output structure;

FIG. 12 is an exploded perspective view for explaining another dielectric waveguide duplexer according to a third embodiment including the dielectric waveguide input/output structure;

FIG. 13 is an exploded perspective view for explaining still another dielectric waveguide duplexer according to a fourth embodiment including the dielectric waveguide input/output structure; and

FIG. 14 is an exploded perspective view for explaining still another dielectric waveguide duplexer according to a fifth embodiment including the dielectric waveguide input/output structure.

### DETAILED DESCRIPTION

Hereinafter, each embodiment of the present disclosure will be described with reference to the drawings. In the drawings, portions where a dielectric is exposed are shown by oblique lines, and portions where a base material is exposed are shown by cross-hatching.

### First Embodiment

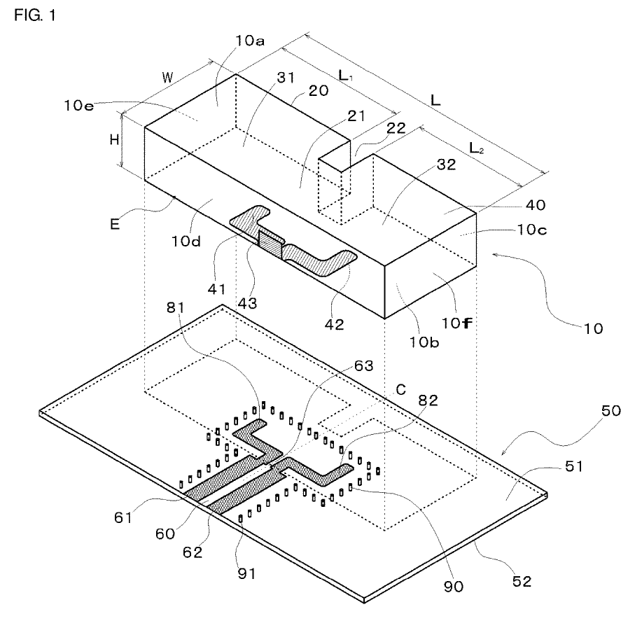

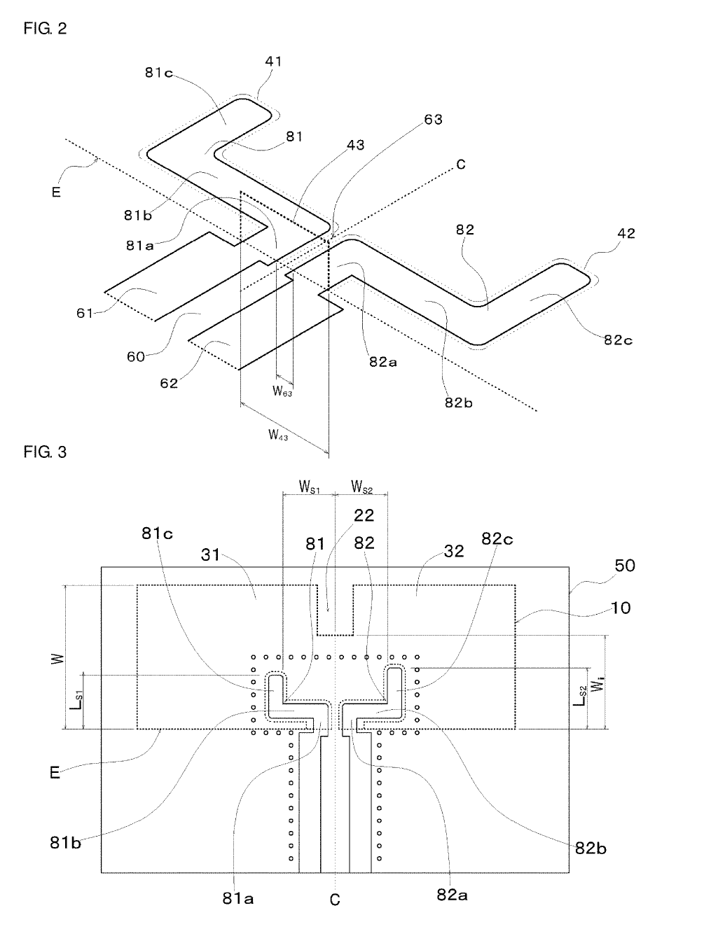

FIG. 1 is an exploded perspective view for explaining a dielectric waveguide input/output structure according to a first embodiment of the present disclosure. FIG. 2 is a partially enlarged view for explaining a conductor non-formation portion in FIG. 1 in detail.

As shown in FIG. 1, a dielectric waveguide 10 in which substantially the entirety of the surface of a dielectric block having a substantially rectangular parallelepiped shape is covered with a conductor film 40 is mounted on a printed circuit board 50. Here, the top surface of the dielectric waveguide 10 is denoted by 10a, the bottom surface thereof is denoted by 10b, the side surfaces thereof are denoted by 10c and 10d, the left end surface thereof is denoted by 10e, the right end surface thereof is denoted by 10f, the sizes of the top surface 10a and the bottom surface 10b are defined as L×W, the sizes of the side surfaces 10c and 10d are defined as L×H, and the sizes of the left end surface 10e and the right end surface 10f are defined as W×H.

In the dielectric waveguide 10, an iris 21 is formed by a groove 22 provided on the side surface 10c, whereby a first resonator 31 having a length L1 from the groove 22 to the left end surface 10e and a second resonator 32 having a length L2 (<L1) from the groove 22 to the right end surface 10f are formed. Here, when the resonant frequency of the resonator 32 is denoted by f1 and the resonant frequency of the resonator 31 is denoted by f2, f1<f2 since L1>L2. Hereinafter, the first resonator 31 side is referred to as “low frequency side”, and the second resonator 32 side is referred to as “high frequency side”. Each of the first resonator 31 and the second resonator 32 serves as a dielectric waveguide resonator in a TE mode.

On the bottom surface 10b of the dielectric waveguide 10, bottom surface dielectric exposure portions 41 and 42 in which the dielectric block is exposed in the substantially same shape as later-described conductor non-formation portions 81 and 82 are provided so as to extend from an edge line E between the bottom surface 10b and the side surface 10d. The outer shapes of the bottom surface dielectric exposure portions 41 and 42 are the same as the outer shapes of the conductor non-formation portions 81 and 82 or are slightly larger than the outer shapes of the conductor non-formation portions 81 and 82. The bottom surface dielectric exposure portion 41 corresponds to a “first dielectric exposure portion” according to the present disclosure, and the bottom surface dielectric exposure portion 42 corresponds to a “second dielectric exposure portion” according to the present disclosure.

On the surface of the printed circuit board 50, a line 60, gaps 61 and 62 in which the base material of the printed circuit board is exposed in a strip shape at both sides of the line 60, and the conductor non-formation portions 81 and 82 which are connected to the gaps 61 and 62 and in which the base material of the printed circuit board is exposed in a crank shape are provided. A surface ground 51 is provided on the remaining portion of the surface of the printed circuit board 50.

The line 60 has a strip-shaped impedance matching portion 63 provided at an end of the line 60, and the impedance matching portion 63 extends from the outer side portion to the inner side portion of the bottom surface 10b of the dielectric waveguide 10, and is connected to the surface ground 51. The impedance matching portion 63 has a smaller width than the line 60 for impedance matching.

When the center line of the groove 22 is defined as a boundary line C, the impedance matching portion 63 is disposed on an extension of the boundary line C, the conductor non-formation portion 81 is disposed on the bottom surface 10b of the dielectric waveguide 10 and at the resonator 31 side, and the conductor non-formation portion 82 is disposed on the bottom surface 10b of the dielectric waveguide 10 at the resonator 32 side.

Meanwhile, a back surface ground 52 is provided on the entirety of the back surface of the printed circuit board 50. Therefore, the line 60, the surface ground 51, and the back surface ground 52 form a grounded coplanar line. That is, the line 60 is a signal line that is a grounded coplanar line.

In addition, in the printed circuit board 50, via holes 90 are provided so as to connect the surface ground 51 and the back surface ground 52 and surround the conductor non-formation portions 81 and 82 in a rectangular shape, and via holes 91 are provided so as to connect the surface ground 51 and the back surface ground 52 and be disposed outside the gaps 61 and 62 and along the line 60.

As shown in FIG. 2, the conductor non-formation portions 81 and 82 respectively include band-shaped regions 81a and 82a which are provided at both sides of the impedance matching portion 63 and extend in parallel to each other, band-shaped regions 81c and 82c which extend in parallel to each other, a band-shaped region 81b which is orthogonal to the region 81a and the region 81c and connects both ends thereof in a crank shape, and a band-shaped region 82b which is orthogonal to the region 82a and the region 82c and connects both ends thereof in a crank shape. That is, the conductor non-formation portion 81 has a crank shape having the region 81a and the region 81c as arms and the region 81b as a shaft, and the conductor non-formation portion 82 has a crank shape having the region 82a and the region 82c as arms and the region 82b as a shaft. These crank-shaped portions are disposed at both sides of the boundary line C such that the regions 81a and 82a are close to the boundary line C and the regions 81c and 82c are away from the boundary line C.

In mounting the dielectric waveguide 10 on the printed circuit board 50, the conductor non-formation portions 81 and 82, which are provided on the printed circuit board 50, are disposed so as to oppose and overlap the bottom surface dielectric exposure portions 41 and 42, respectively, which are provided on the dielectric waveguide 10. When the conductor non-formation portions 81 and 82, which are provided on the printed circuit board 50, are larger than the bottom surface dielectric exposure portions 41 and 42, which are provided on the dielectric waveguide 10, the bottom surface dielectric exposure portions 41 and 42 of the dielectric waveguide 10 are disposed at the inner side portions of the conductor non-formation portions 81 and 82 of the printed circuit board, respectively.

When the conductor non-formation portions 81 and 82, which are provided on the printed circuit board 50, are larger than the bottom surface dielectric exposure portions 41 and 42, which are provided on the dielectric waveguide 10, there is an effect that variations in connection between the line 60 and the dielectric resonators 31 and 32 with respect to displacement of the position where the dielectric waveguide 10 is mounted are small.

At this time, a side surface dielectric exposure portion 43 in which the dielectric block is exposed is provided near the impedance matching portion of the side surface 10d of the dielectric waveguide 10 such that short-circuit between the impedance matching portion 63, which is provided on the printed circuit board 50, and the conductor film 40 of the dielectric waveguide 10 is prevented. The width W43 of the side surface dielectric exposure portion 43 is larger than the width W63 of the impedance matching portion 63. However, the side surface dielectric exposure portion 43 is preferably as small as possible for reducing unwanted radiation from the side surface dielectric exposure portion 43. In addition, it is difficult to provide the side surface dielectric exposure portion 43 on the inner wall of the groove 22, and thus it is preferable to provide the side surface dielectric exposure portion 43 at the side surface 10d side at which no groove is present. The side surface dielectric exposure portion 43 corresponds to a “third dielectric exposure portion” according to the present disclosure.

FIG. 3 is a plan view for explaining the dimensions of each portion of the dielectric waveguide input/output structure of the present embodiment. As shown in FIG. 3, the distance from the edge line E to the distal end of the conductor non-formation portion 81 is denoted by LS1, the distance from the edge line E to the distal end of the conductor non-formation portion 82 is denoted by LS2, the distance from the boundary line C to the right end of the region 81c is denoted by WS1, the distance from the boundary line C to the left end of the region 82c is denoted by WS2, and the distance from the edge line E to the bottom of the groove 22 is denoted by Wi.

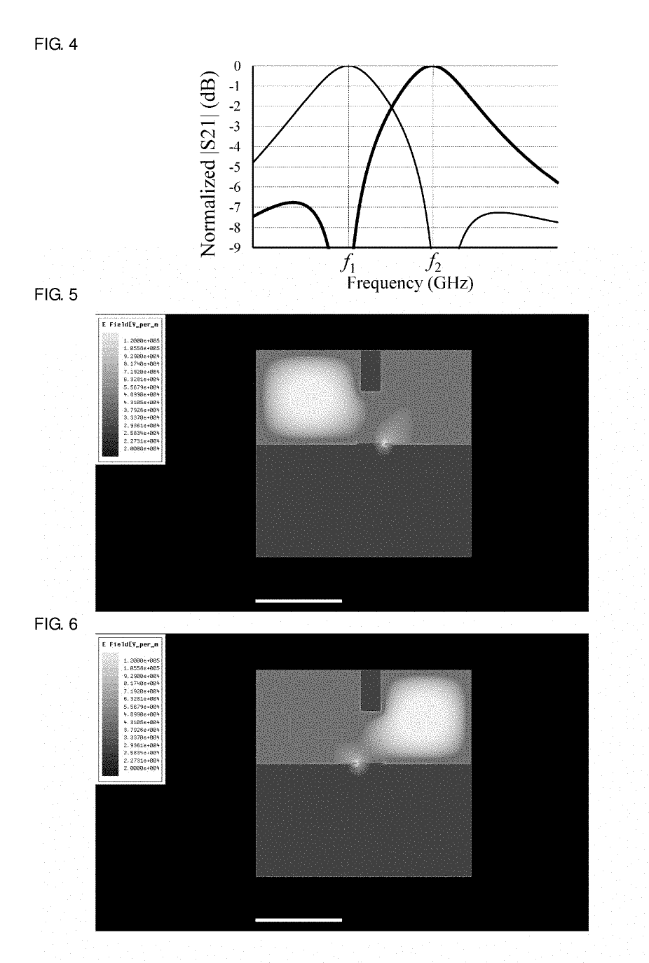

FIG. 4 is a diagram showing simulation results of bandpass characteristics (S21) of the dielectric waveguide input/output structure of the present embodiment, a result obtained by normalizing bandpass characteristics at the low frequency side by a frequency f1 is shown by a thick line, and a result obtained by normalizing bandpass characteristics at the high frequency side by a frequency f2 is shown by a thin line.

FIGS. 5 and 6 are diagrams showing simulation results of a field strength distribution of the dielectric waveguide input/output structure of the present embodiment, FIG. 5 shows a field strength distribution at the frequency f1, and FIG. 6 shows a field strength distribution at the frequency f2. In FIGS. 5 and 6, a lower density indicates higher field strength. From the results in FIGS. 4, 5, and 6, it appears that the dielectric waveguide input/output structure of the present embodiment is able to distribute and input a signal from the line 60 (from the grounded coplanar line) to the resonators 31 and 32.

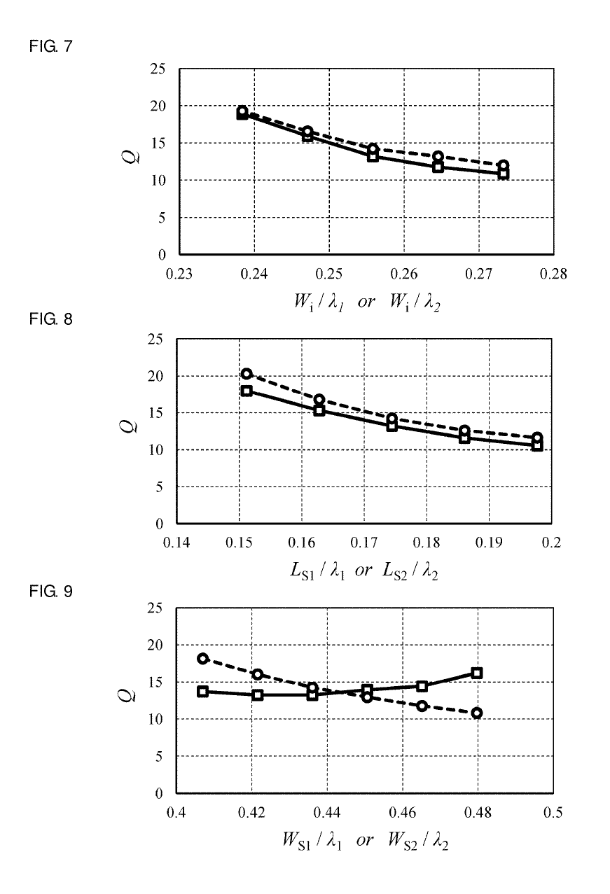

FIG. 7 is a diagram showing simulation results of an outer portion Q of the dielectric waveguide input/output structure in the case where Wi is changed. In FIG. 7, the horizontal axis indicates Wi/λ1 or Wi/λ2, the vertical axis indicates the outer portion Q, a solid line indicates the outer portion Q at the low frequency side, and a broken line indicates the outer portion Q at the high frequency side. Here, λ1 is a wavelength within the dielectric waveguide at the frequency f1, and λ2 is a wavelength within the dielectric waveguide at the frequency f2.

FIG. 8 is a diagram showing simulation results of the outer portion Q of the dielectric waveguide input/output structure in the case where LS1 or LS2 is changed. In FIG. 8, the horizontal axis indicates LS1/λ1 or LS2/λ2, the vertical axis indicates the outer portion Q, a solid line indicates the outer portion Q at the low frequency side, and a broken line indicates the outer portion Q at the high frequency side.

FIG. 9 is a diagram showing simulation results of the outer portion Q of the dielectric waveguide input/output structure in the case where WS1 or WS2 is changed. In FIG. 9, the horizontal axis indicates WS1/λ1 or WS2/λ2, the vertical axis indicates the outer portion Q, a solid line indicates the outer portion Q at the low frequency side, and a broken line indicates the outer portion Q at the high frequency side.

From the results in FIGS. 7 and 8, it appears that the outer portions Q at the high frequency side and the low frequency side change so as to fall. On the other hand, from the results in FIG. 9, it appears that the outer portion Q at the low frequency side rises and the outer portion Q at the high frequency side falls. From these results, it appears that the outer portion Q at the high frequency side and the outer portion Q at the low frequency side allow the ratio thereof on the basis of WS1 and WS2 while adjusting the magnitudes thereof on the basis of Wi, LS1, and LS2. When this relationship is used, it is possible to adjust bandwidths at the high frequency side and the low frequency side. The resonator 31 and the resonator 32 are connected to each other. When the connection is excessively small, the bandwidth becomes narrow. Therefore, the depth of the groove 22 is also one of parameters for adjusting the outer portion Q.

In each of the results in FIGS. 7, 8, and 9, the outer portion Q is lower than or equal to 20. Therefore, the dielectric waveguide input/output structure of the present embodiment is considered to have a wideband structure.

In the present embodiment, the line 60 is formed as a grounded coplanar line, and the via holes 91 are provided along both sides of the coplanar line. However, the via holes 91 may be omitted, and further a coplanar line may be formed by omitting the back surface ground 52 at the back side of the line 60, or a microstrip line may be formed by omitting the surface ground 51 at both sides of the line 60. Also, in the present embodiment, the conductor non-formation portions 81 and 82 have crank shapes with different dimensions as described above, but may have symmetrical shapes with the same dimensions, and the regions 81b and 82b, which are the shaft portions of the crank shapes, may be straight or may not be straight.

Furthermore, in the dielectric waveguide, the plurality of resonators are formed by the iris 21 formed by the groove 22, but a plurality of resonators may be formed by an iris formed by a through hole or the like.

### Second Embodiment

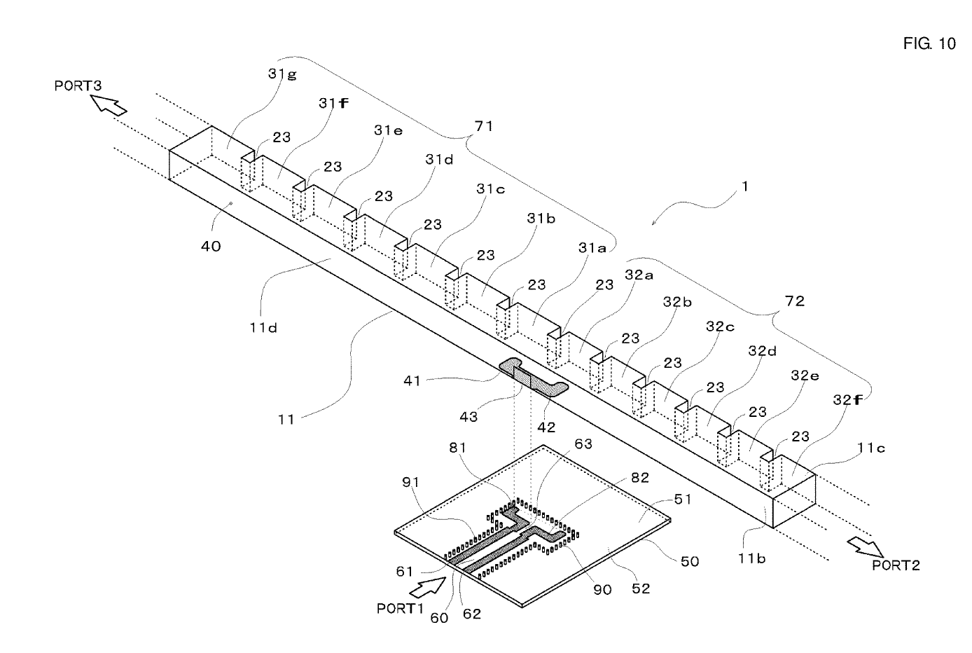

FIG. 10 is a an exploded perspective view for explaining a dielectric waveguide duplexer according to a second embodiment including the dielectric waveguide input/output structure described in the first embodiment. In FIG. 10, a printed circuit board 50, and bottom surface dielectric exposure portions 41 and 42 and a side surface dielectric exposure portion 43 provided on a dielectric waveguide, are the same as those in the dielectric waveguide input/output structure described in the first embodiment, and thus are designated by the same reference signs, and the description thereof is omitted. As shown in FIG. 10, a dielectric waveguide 11 in which substantially the entirety of the surface of a dielectric block having a substantially rectangular parallelepiped shape is coated with a conductor film 40 is mounted on the printed circuit board 50.

The dielectric waveguide 11 is divided by irises formed by a plurality of grooves 23 provided on a side surface 11c, whereby a plurality of resonators 31g, 31f, 31e, 31d, 31c, 31b, 31a, 32a, 32b, 32c, 32d, 32e, and 32f are formed. Among these resonators, the resonators 31a, 31b, 31c, 31d, 31e, 31f, and 31g form a filter 71 at the low frequency side, and the resonators 32a, 32b, 32c, 32d, 32e, and 32f form a filter 72 at the high frequency side. Each resonator serves as a dielectric waveguide resonator in a TE mode. Among the plurality of resonators, the resonator 31a corresponds to a “first resonator” according to the present disclosure, and the resonator 32a corresponds to a “second resonator” according to the present disclosure.

The side surface dielectric exposure portion 43 is provided on a side surface 11d of the dielectric waveguide 11 and in the region between the resonator 31a and the resonator 32a, the bottom surface dielectric exposure portion 41 is provided on the bottom surface 11b of the dielectric waveguide 11 and in the region of the resonator 31a, and the bottom surface dielectric exposure portion 42 is provided on the bottom surface of the dielectric waveguide 11 and in the region of the resonator 32a. Here, the resonant frequency of the resonator 31a is denoted by f1, and the resonant frequency of the resonator 32a is denoted by f2 (>f1).

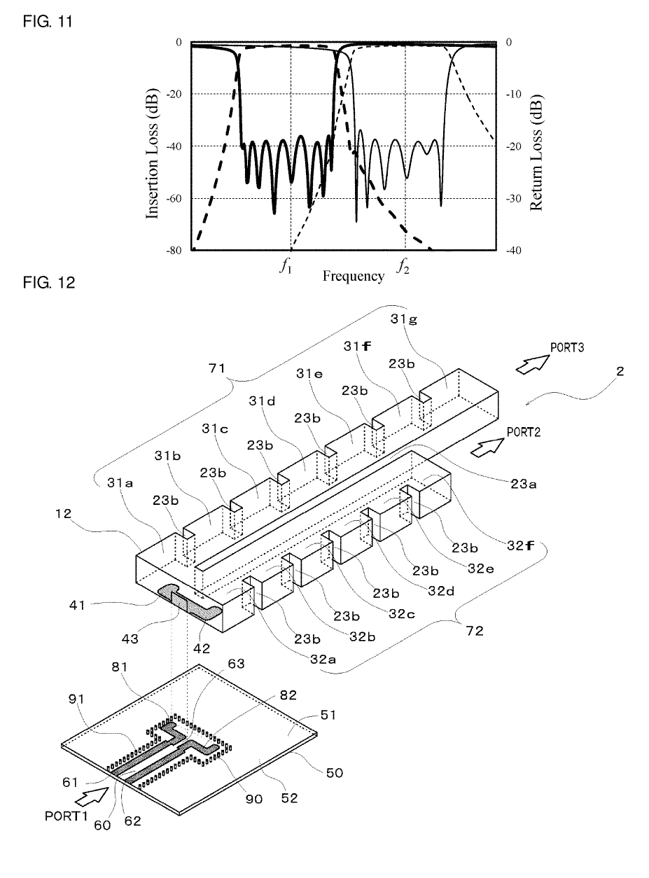

FIG. 11 is a diagram showing simulation results of the dielectric waveguide duplexer 1 of the present embodiment. When the grounded coplanar line including the line 60 is denoted by PORT1, the resonator 32f is denoted by PORT2, and the resonator 31g is denoted by PORT3 in FIG. 10, a thick solid line indicates return loss S33 of PORT3, a thick broken line indicates insertion loss S13 from PORT3 to PORT1, a thin solid line indicates return loss S22 of PORT2, and a thin broken line indicates insertion loss S12 from PORT2 to PORT1.

From the results in FIG. 11, it appears that the dielectric waveguide 11 operates as a duplexer having the frequencies f1 and f2 as center frequencies. The grooves 23 other than the groove 23 between the resonator 31a and the resonator 32a may be provided at the side surface 11d side parallel to the side surface 11c.

### Third Embodiment

FIG. 12 is an exploded perspective view for explaining a dielectric waveguide duplexer according to a third embodiment including the dielectric waveguide input/output structure described in the first embodiment. The dielectric waveguide duplexer 2 of the present embodiment is different from the dielectric waveguide duplexer 1 described in the second embodiment, in that a dielectric waveguide 12 having a substantially U shape is used.

In the dielectric waveguide duplexer 1 of the second embodiment, when the number of resonators increases, the overall length of the dielectric waveguide duplexer increases. In the dielectric waveguide duplexer 2 of the present embodiment, by forming a portion between the resonator 31a and the resonator 32a in a U or J shape bent by 180°, the overall length is shortened, and the directions of PORTS are changed.

The dielectric waveguide duplexer 2 includes a first dielectric waveguide portion forming a filter 71, and a second dielectric waveguide portion forming a filter 72. In the filter 71, the resonators 31a to 31g are arranged in a line, and one end direction is the direction of an input/output port PORT3. In the filter 72, the resonators 32a to 32f are arranged in a line, and one end direction is the direction of an input/output port PORT2.

The direction of the input/output port PORT3 of the filter 71 is the same as the direction of the input/output port PORT2 of the filter 72. The first resonator 31a is provided at an end portion of the filter 71 away from the input/output port PORT3, and the second resonator 32a is provided at an end portion of the filter 72 away from the input/output port PORT2. The first resonator 31a and the second resonator 32a are demarcated by an iris formed by a groove 23a and structurally connected to each other.

It is difficult to perform processing for providing all the grooves on the inner side surface of a U or J shape. Thus, in the present embodiment, the grooves 23b other than the groove 23a between the filter 71 and the filter 72 are provided on the outer side surface of the dielectric waveguide 12. This structure makes processing easier.

### Fourth Embodiment

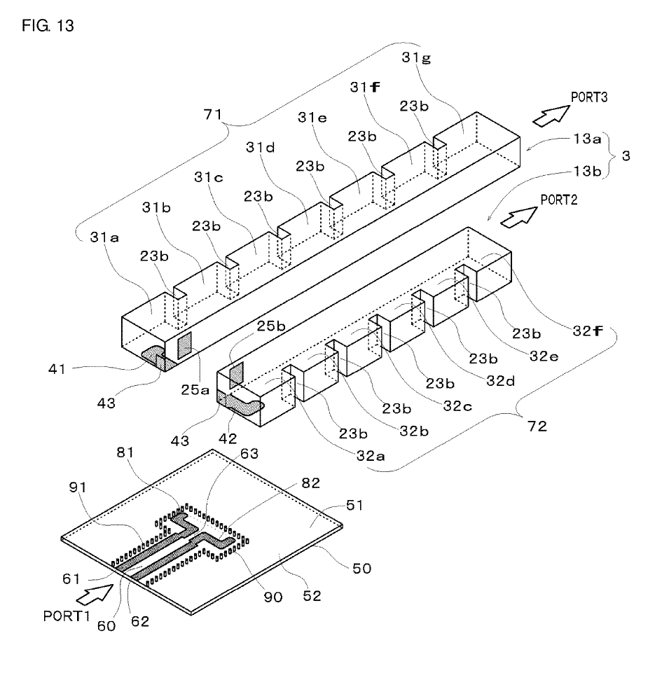

FIG. 13 is an exploded perspective view for explaining a dielectric waveguide duplexer according to a fourth embodiment including the dielectric waveguide input/output structure described in the first embodiment. The dielectric waveguide duplexer 3 of the present embodiment is different from the dielectric waveguide duplexer 2 described in the third embodiment, in that two dielectric waveguides 13a and 13b having a substantially rectangular parallelepiped shape are connected to each other via connection windows 25a and 25b.

As shown in FIG. 13, the dielectric waveguide duplexer 3 includes a dielectric waveguide 13a and a dielectric waveguide 13b which have a substantially rectangular parallelepiped shape. The dielectric waveguide 13a corresponds to a “first dielectric waveguide portion” according to the present disclosure, and the dielectric waveguide 13b corresponds to a “second dielectric waveguide portion” according to the present disclosure. The dielectric waveguide 13a is divided by irises formed by grooves 23 provided on a side surface thereof, whereby a plurality of resonators 31a, 31b, 31c, 31d, 31e, 31f, and 31g are formed. The dielectric waveguide 13b is divided by irises formed by grooves 23 provided on a side surface thereof, whereby a plurality of resonators 32a, 32b, 32c, 32d, 32e, and 32f are formed. The resonator 31a corresponds to the “first resonator” according to the present disclosure, and the resonator 32a corresponds to the “second resonator” according to the present disclosure.

The dielectric waveguide 13a and the dielectric waveguide 13b are arranged side by side, so that the first resonator 31a and the second resonator 32a are disposed adjacent to each other. The dielectric waveguide 13a and the dielectric waveguide 13b are connected to each other via the connection windows 25a and 25b which are provided in side surfaces of the respective resonators 31a and 32a and in which a dielectric block is exposed in a rectangular shape. The side surface dielectric exposure portion 43 is provided so as to be divided on end surfaces of the dielectric waveguide 13a and the dielectric waveguide 13b. Such dielectric waveguides having a shape that makes processing easy may be combined using connection windows.

### Fifth Embodiment

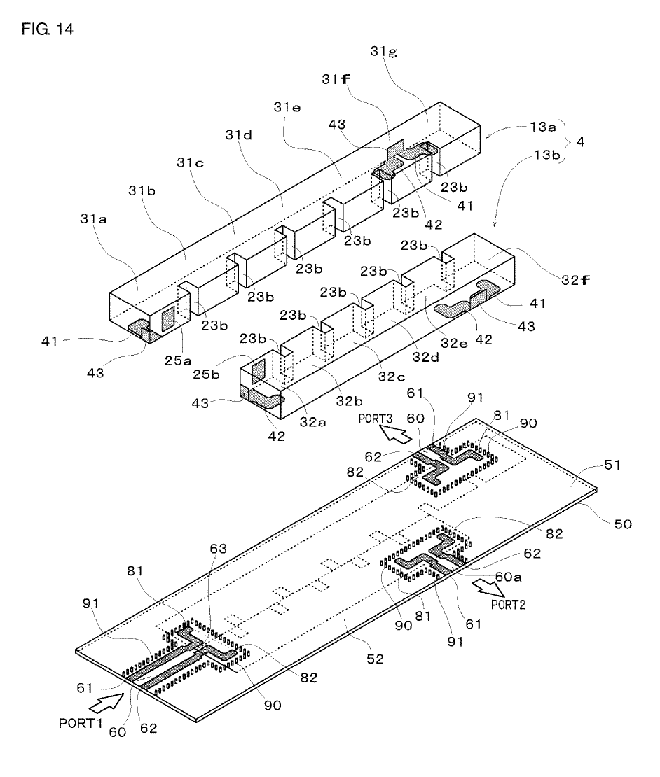

FIG. 14 is an exploded perspective view for explaining a dielectric waveguide duplexer according to a fifth embodiment including the dielectric waveguide input/output structure described in the first embodiment. The dielectric waveguide duplexer 4 of the present embodiment is a dielectric waveguide duplexer having a resonator 31g and a resonator 32f as trap resonators.

As shown in FIG. 14, the dielectric waveguide input/output structure described in the first embodiment is used for a resonator 31f and the resonator 31g and for a resonator 32e and the resonator 32f. The dielectric waveguide 13a and the dielectric waveguide 13b are disposed such that the side surfaces thereof on which the grooves 23b are provided are adjacent to each other, for the convenience of the direction in which lines for PORT2 and PORT3 on the printed circuit board 50 are extended.

As described in each of the above embodiments, the dielectric waveguide input/output structure of the present disclosure is applicable to various branch structures which distribute one signal to two dielectric waveguides.

What is claimed is:

1. A dielectric waveguide input/output structure comprising:
a printed circuit board on which a line is provided; and
a dielectric waveguide, the dielectric waveguide and the line being connected to each other, and the dielectric waveguide including:
a first resonator and a second resonator disposed adjacent to each other, on a surface of the printed circuit board,
an impedance matching portion connected to an end of the line and extending from an outer side portion to an inner side portion of a bottom surface of the dielectric waveguide,
a gap provided at each side of the line,
a first conductor non-formation portion connected to the gap, disposed on a bottom surface of the dielectric waveguide and at the first resonator side, and having a crank shape,
a second conductor non-formation portion connected to the gap, disposed on the bottom surface of the dielectric waveguide and at the second resonator side, and having a crank shape, and
a surface ground provided on a remaining part other than the first conductor non-formation portion and the second conductor non-formation portion,
wherein
a back surface ground is provided on a back surface of the printed circuit board,
via holes connecting the surface ground and the back surface ground are provided so as to surround the first conductor non-formation portion and the second conductor non-formation portion,
a first dielectric exposure portion and a second dielectric exposure portion are provided on bottom surfaces of the first resonator and the second resonator so as to overlap the first conductor non-formation portion and the second conductor non-formation portion, respectively,
a third dielectric exposure portion is provided on a side surface of the dielectric waveguide and near the line, and
the dielectric waveguide is mounted on the printed circuit board such that the first conductor non-formation portion and the second conductor non-formation portion overlap the first dielectric exposure portion and the second dielectric exposure portion, respectively.

2. The dielectric waveguide input/output structure according to claim 1, wherein the impedance matching portion has a width smaller than that of the line.

3. The dielectric waveguide input/output structure according to claim 1, wherein
the first dielectric exposure portion and the second dielectric exposure portion are larger than outer shapes of the first conductor non-formation portion and the second conductor non-formation portion, and
the dielectric waveguide is mounted on the printed circuit board such that the first conductor non-formation portion and the second conductor non-formation portion are disposed at inner side portions of the first dielectric exposure portion and the second dielectric exposure portion, respectively.

4. The dielectric waveguide input/output structure according to claim 1, wherein the first conductor non-formation portion and the second conductor non-formation portion are asymmetrical to a boundary line between the first resonator and the second resonator.

5. The dielectric waveguide input/output structure according to claim 1, wherein the line is a signal line which is a microstrip line, a coplanar line, or a grounded coplanar line.

6. The dielectric waveguide input/output structure according to claim 1, wherein the first resonator and the second resonator are demarcated by an iris formed by a groove provided on the side surface of the dielectric waveguide.

7. The dielectric waveguide input/output structure according to claim 1, wherein
the dielectric waveguide includes a first dielectric waveguide portion in which a plurality of resonators are arranged in a line and one end direction is an direction of an input/output port, and a second dielectric waveguide portion in which a plurality of resonators are arranged in a line and one end direction is an direction of an input/output port,
the input/output ports of the first dielectric waveguide portion and the second dielectric waveguide portion face in the same direction,
the first resonator is provided at an end portion of the first dielectric waveguide portion away from the input/output port,
the second resonator is provided at an end portion of the second dielectric waveguide portion away from the input/output port, and
the first resonator and the second resonator are connected to each other.

8. The dielectric waveguide input/output structure according to claim 1, wherein
the dielectric waveguide includes a first dielectric waveguide portion in which a plurality of resonators are arranged in a line and one end direction is an direction of an input/output port, and a second dielectric waveguide portion in which a plurality of resonators are arranged in a line and one end direction is an direction of an input/output port,
the first resonator is provided in the first dielectric waveguide portion,
the second resonator is provided in the second dielectric waveguide portion, and
the first dielectric waveguide portion and the second dielectric waveguide portion are arranged side by side, whereby the first resonator and the second resonator are disposed adjacent to each other.

9. The dielectric waveguide input/output structure according to claim 8, wherein the first resonator and the second resonator are connected to each other via connection windows provided in the side surface of the dielectric waveguide.

10. A dielectric waveguide duplexer including two dielectric waveguide resonators and including the dielectric waveguide input/output structure according to claim 1 at an input portion to the two dielectric waveguide resonators.

11. The dielectric waveguide input/output structure according to claim 2, wherein the first conductor non-formation portion and the second conductor non-formation portion are asymmetrical to a boundary line between the first resonator and the second resonator.

12. The dielectric waveguide input/output structure according to claim 3, wherein the first conductor non-formation portion and the second conductor non-formation portion are asymmetrical to a boundary line between the first resonator and the second resonator.

13. The dielectric waveguide input/output structure according to claim 2, wherein the line is a signal line which is a microstrip line, a coplanar line, or a grounded coplanar line.

14. The dielectric waveguide input/output structure according to claim 3, wherein the line is a signal line which is a microstrip line, a coplanar line, or a grounded coplanar line.

15. The dielectric waveguide input/output structure according to claim 2, wherein the first resonator and the second resonator are demarcated by an iris formed by a groove provided on the side surface of the dielectric waveguide.

16. The dielectric waveguide input/output structure according to claim 3, wherein the first resonator and the second resonator are demarcated by an iris formed by a groove provided on the side surface of the dielectric waveguide.

17. The dielectric waveguide input/output structure according to claim 2, wherein
the dielectric waveguide includes a first dielectric waveguide portion in which a plurality of resonators are arranged in a line and one end direction is an direction of an input/output port, and a second dielectric waveguide portion in which a plurality of resonators are arranged in a line and one end direction is an direction of an input/output port,
the input/output ports of the first dielectric waveguide portion and the second dielectric waveguide portion face in the same direction,
the first resonator is provided at an end portion of the first dielectric waveguide portion away from the input/output port,
the second resonator is provided at an end portion of the second dielectric waveguide portion away from the input/output port, and
the first resonator and the second resonator are connected to each other.

18. The dielectric waveguide input/output structure according to claim 2, wherein
the dielectric waveguide includes a first dielectric waveguide portion in which a plurality of resonators are arranged in a line and one end direction is an direction of an input/output port, and a second dielectric waveguide portion in which a plurality of resonators are arranged in a line and one end direction is an direction of an input/output port,
the first resonator is provided in the first dielectric waveguide portion,
the second resonator is provided in the second dielectric waveguide portion, and
the first dielectric waveguide portion and the second dielectric waveguide portion are arranged side by side, whereby the first resonator and the second resonator are disposed adjacent to each other.

19. The dielectric waveguide input/output structure according to claim 18, wherein the first resonator and the second resonator are connected to each other via connection windows provided in the side surface of the dielectric waveguide.

20. A dielectric waveguide duplexer including two dielectric waveguide resonators and including the dielectric waveguide input/output structure according to claim 2 at an input portion to the two dielectric waveguide resonators.
